(19) United States
(12) Patent Application Publication
(10) Pub. No.: US 2008/0217394 A1
(43) Pub. Date: Sep. 11, 2008

(54) Operation support system, component arrangement recognition method and cassette arrangement recognition method in component mounting apparatus

(75) Inventors: Hiroyuki Okada, Kahoku (JP); Mitsuhiro Iida, Kahoku (JP); Shigejirou Matsumoto, Kahoku (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/153,379

(22) Filed: May 16, 2008

Related U.S. Application Data
(63) Continuation of application No. PCT/JP2005/021288, filed on Nov. 18, 2005.

(51) Int. Cl. G06F 17/00

(52) U.S. Cl. 235/375

(57) ABSTRACT

An operation support system in a component mounting apparatus on a manufacturing line for manufacturing printed board units, comprises: an ID reading unit that reads out cassette identification information for identifying cassettes and component identification information for identifying components from the cassette each comprising tags for recording the cassette identification information and tags for recording the component identification information, wherein at least one reels are loaded on each cassette and tapes to which the components are attached are wound around the reels, and the components are contained in the reels accommodated in the cassettes; a storage unit that stores information for specifying the components previously set to be loaded on the cassettes; and a component loading checking unit that checks whether or not the components loaded on the cassettes are correct by comparing the component identification information with the specifying information corresponding to the cassette identification information.

### CROSS-REFERENCE TO RELATED APPLICATION

This application is a continuation application and is based upon PCT/JP2005/021288, filed on Nov. 18, 2005.

### TECHNICAL FIELD

The present invention relates to an operation support system, a component loading state recognition method and a cassette loading state recognition method in a component mounting apparatus, and specifically, it relates to an operation support system, a method for recognizing a component loading state in cassettes on which components are loaded and a method for recognizing a cassette loading state in carts on which the cassettes are loaded in a printed board component mounting apparatus that is provided on a manufacturing line for manufacturing printed board units in which the components are incorporated into printed boards and that mounts the components on the printed boards.

### BACKGROUND ART

Patent Document 1 describes a component management apparatus intended for a printed board mounting system. As shown in FIG. 1 of Patent document 1, bar codes that record identification information are applied to respective cassettes 21, and a system server 1 generates change history information by combining the identification information recorded in the bar codes of the cassettes 21 with information recorded in bar codes applied to respective component reels 36 loaded on the cassettes 21 and uses the change history information for component management.

Patent Document 2 describes a pallet organization system that can be applied to a component mounting apparatus (mounter) where a plurality of pallets 36 on which cartridges 35 for components to be mounted are loaded and printed boards 28 on which the components are to be mounted are supplied, as shown in FIGS. 3 and 4 of Patent Document 2. As shown in FIG. 3 of Patent Document 2, in each of reels 31 loaded on the respective cartridges 35, a strip-like component case in which multiple identical components are accommodated longitudinally and equidistantly wound therearound.

As shown in FIG. 4 of Patent Document 2, when the pallets 36 are fed to a component mounting machine 15 that operates to mount the components at predetermined positions on the printed boards 28, the pallet organization system generates channel setting data that indicates which cartridges 35 are loaded on which channels of the pallets 36 and it is configured to supply racks 34 accommodating the printed boards 28, to which ID labels are applied on a lifter 42 by a belt conveyor 41, feed the desired printed boards 28 accommodated in the racks 34 into the small-sized component mounting machine 15 by a pusher 43, mount the components supplied from the pallets 36, which are carried to the small-sized component mounting machine 15 from self-propelled wagons (carts) 26, on the printed boards 28, and then returns the printed boards 28 to the racks 34.

Conventionally, as described in paragraphs [0015]-[10019] and FIG. 2 of Patent Document 2, the manufacturing line for manufacturing the printed board units in which the components are incorporated into the printed boards is typically constituted of: a printing machine for printing paste solder on component attachment lands of the printed boards; an adhering machine for applying adhesive to the component attachment lands of the printed boards; a printed board component mounting apparatus (hereinafter referred to as a mounter) for mounting the components such as electronic components on the printed boards; a reflow apparatus for hardening the solder by heat treatment; and so on. In particular, the mounter is an important apparatus that determines the ability of the manufacturing line.

In the mounter, there occur various problems such as an increase in man-hours, occurrence of defectives due to erroneous operation, manufacturing line shutdown for long hours and so on. Therefore, in order to solve these problems, a new component set up operation and a system for supporting such operation are needed.

For example, the following two auxiliary units of the mounter affect the component set up operation:

(1) cassettes that can accommodate a plurality of reels around each of which a tape is wound, wherein the components are attached to the tape; and

(2) wagons (carts) that carry cassette jigs that can be detached from the mounter.

With regard to the cassettes of (1), in order to set the reels on the mounter, the reels have to be loaded on the cassettes. In recent years, as component sizes become smaller and reel sizes also become smaller for narrow adjacent mounting, cassettes on each of which a plurality of reels can be loaded to be used for efficiently utilizing a space of the entire mounter are required.

With regard to the cart of (2), in recent years, for convenience of set up change, there is a shift toward a mounter system in which the cassettes are loaded on the carts that can be detached from the mounter.

The cassettes of (1) have a problem in that, if the reel loading positions in the cassettes are erroneously recognized, the components contained in the reels will be erroneously mounted on the printed boards.

The carts of (2) have a problem in that, if the cassette loading positions in the carts are erroneously recognized, the components contained in the cassettes loaded on the carts will be erroneously mounted on the printed boards. A specific example of the problem with regard to the carts of (2) will be described as follows. In the component management system intended for the printed board mounting system as set forth in Patent Document 1, after the component reels 36 are loaded on cassettes 21, the cassettes 21 may be accommodated in improper lane positions among the plurality of lanes Z1-Zn in the mounter 20 due to erroneous operation, and in this case, there is a problem in that the mounter 20 cannot attach the component to proper positions on the printed boards or in other words, erroneous mounting will occur and faulty printed board units will be manufactured.

The pallet organization system as set forth in Patent Document 2 has a problem in that, when the pallets 36 are carried to the small-sized component mounting machine 15 by the self-propelled wagons 26, which cartridges 35 are loaded on which channels of the pallets 36 by manually or bar code verification, is verified and therefore, it takes considerable time.

Further, when the carts are set in the mounter from which a plurality of carts can be detached, there is also a problem in that, if the plurality of carts are set in improper positions of the mounter, the components will be erroneously mounted on the printed boards.

[Patent Document 1]

Japanese Unexamined Patent Publication No. 2001-127487 (See Claim 1 (in particular, reading means), paragraphs [0009]-[0011], [0014]-[0018], [0022], [0023], [0055] and [0056], FIGS. 1, 3 and 8, and Abstract of the patent specification thereof.)

[Patent Document 2]

Japanese Patent Specification No. 2,642,800 (See Claim 1, paragraphs [0005]-[0010], FIGS. 1-4.)

### DISCLOSURE OF THE INVENTION

### Problem to be Solved by the Invention

The present invention has been made to solve the above problems and it is an object of the present invention to improve efficiency of component set up operation and eliminate erroneous mounting of components on printed boards in a printed board component mounting apparatus.

### Means for Solving the Problem

In order to achieve the above object, according to a first embodiment of the present invention, there is provided an operation support system in a component mounting apparatus for mounting components on objects, characterized in that it comprises: a reading unit that reads out cassette identification information and component identification information from cassettes, wherein each of the cassettes comprises: a first recording section that records the component identification information for identifying components contained in at least one reel accommodated in the cassettes, and a second recording section that records the cassette identification information for identifying the cassettes; a storage unit that stores information for specifying the components previously set to be loaded on the cassettes; and a component loading checking unit that checks whether the components loaded on the cassettes are correct ones or not by comparing the component identification information with the specifying information corresponding to the cassette identification information.

In order to achieve the above object, according to a second embodiment of the present invention, there is provided an operation support system in a component mounting apparatus for mounting components on objects, characterized in that it comprises: a reading unit that reads out cassette identification information and component identification information from cassettes, wherein each of the cassette comprises: a first recording section that records the component identification information for identifying components contained in at least one reel accommodated in the cassettes, and a second recording section that records the cassette identification information for identifying the cassettes; a storage unit that stores information for specifying loading positions of the components set in the component mounting apparatus; and a component loading checking unit that checks whether the component loading positions in the component mounting apparatus are correct or not by comparing the component identification information with the specifying information corresponding to the cassette identification information.

In the first or second embodiment described above, the cassette identification information includes at least information for identifying reels loaded on the cassettes, or components attached to the reels.

In the first or second embodiment described above, the first recording section is provided for each reel and the reading unit reads out the component identification information for each reel.

In the first or second embodiment described above, the first and/or second recording sections are bar codes for recording data, and the reading unit has a bar code reader for reading the bar codes.

In the first or second embodiment described above, the first and/or second recording sections are wireless IC tags for recording data, and the reading unit has an antenna for receiving radio wave from the wireless IC tags and reads out the data via such antenna.

In order to achieve the above object, according to a third embodiment of the present invention, there is provided an operation support system in a component mounting apparatus for mounting components on objects, characterized in that it comprises: a reading section that moves by itself to positions where cassettes are loaded on carts each having a plurality of lanes to read out, from the cassettes, at least one of component identification information for identifying components loaded on the cassettes and cassette identification information for identifying the cassettes; a storage section that stores information for specifying previously set cassette loading positions in the carts; and a cassette loading checking section that checks whether the cassette loading positions in the carts are correct or not by comparing the component identification information or the cassette identification information with the specifying information.

In order to achieve the above object, according to a fourth embodiment of the present invention, there is provided an operation support system in a component mounting apparatus for mounting components on objects, characterized in that it comprises: a reading section that moves by itself to positions where cassettes are loaded on carts each having a plurality of lanes to read out cassette identification information for identifying the cassettes from the cassettes; a storage section that stores information for specifying lanes where the cassettes are loaded in the carts; and a cassette loading checking section that checks whether cassette loading positions in the carts are correct or not by comparing the cassette identification information read out by the reading section with the lane specifying information.

In order to achieve the above object, according to a fifth embodiment of the present invention, there is provided an operation support system in a component mounting apparatus for mounting components on objects, characterized in that it comprises: a reading section that moves by itself to positions where cassettes are loaded on carts each having a plurality of lanes to read out, from the cassettes, component identification information for identifying components loaded on the cassettes; a storage section that stores information for specifying lanes where the components are loaded in the carts; and a component loading checking section that checks whether component loading positions in the carts are correct or not by comparing the component identification information read out by the reading section with the lane identification information.

In the third, fourth or fifth embodiment described above, a plurality of carts can be loaded on the component loading apparatus, each of the carts comprises a third recording section that records cart identification information for identifying such cart, and the cassette loading checking section checks a cassette loading arrangement in each cart.

In the third, fourth or fifth embodiment described above, the recording section is bar codes for recording data, and the cassette loading checking section has a bar code reader for reading the bar codes.

In the third, fourth or fifth embodiment described above, the recording section is wireless IC tags for recording data, and the cassette loading checking section has an antenna for receiving radio wave from the wireless IC tags and reading out the data via such antenna.

### EFFECT OF THE INVENTION

In the component mounting apparatus of the first or second embodiment of the present invention, because the cassettes and the reels are recognized in a state in which the reels containing the components are loaded on the cassettes, the reel positions in the cassettes, and thus, the components can be properly recognized and, therefore, it is possible to mount the properly recognized components on the intended printed boards and eliminate erroneous mounting.

More specifically, after the reels containing the components are loaded on the cassettes, the data recorded in the bar codes stuck on the reels or the wireless IC tags incorporated into the reels is read out to recognize the cassettes and the reels and, therefore, the reel positions in the cassettes, and thus, the components can be properly recognized.

Further, in the component mounting apparatus of the first or second embodiment, when a plurality of different types of the components are accommodated in one cassette, the information of the different types of the components is recorded on each reel in the one identical cassette, and therefore, the reel positions in the cassettes, and thus, the components can be properly recognized, and further, it is possible to eliminate erroneous mounting of the components on the intended printed boards due to downsizing of the cassettes as a result of downsizing of the component mounting apparatus.

Still further, even if the actual mounter on the manufacturing line is operating, it can be checked where the components are loaded in the cassettes at a location remote from the manufacturing line, and therefore, operational efficiency and workability can be improved.

In the operation support system of third, fourth or fifth embodiment of the present invention, because the cassette loading checking section moves by itself to read out the cassette identification information for identifying the cassettes loaded on a plurality of lanes, obtains the identification information of the components loaded on the cassettes from the cassette identification information, and determines whether the cassette loading positions in the carts are correct or not by comparing the obtained component identification information with the previously set information for specifying the cassette loading positions in the carts, the cassette loading positions in the carts can be properly recognized, and therefore, operating time for loading the cassettes on the lanes in the carts can be reduced and workability can be improved. Further, there is an effect that the components contained in the cassettes loaded on the cassettes can be properly recognized, and therefore, the erroneous mounting of the components on the intended printed boards due to erroneous operation when the cassettes are loaded on the lanes can be avoided.

Further, in the operation support system of third, fourth or fifth embodiment, by configuring said reading section, for example, the antenna to be self-propelled, the need to provide a plurality of reading sections (antennas) receiving the cassette identification information corresponding to the number of cassettes loaded on the carts can be eliminated and an inexpensive operation support system can be implemented.

Still further, in the operation support system of third, fourth or fifth embodiment, because the cart identification information for identifying the carts is read out and it is automatically checked whether the carts are properly loaded or not on the component mounting apparatus on which a plurality of carts can be loaded, and therefore, the erroneous mounting of the components on the intended printed boards due to the erroneous loading of the carts on the component mounting apparatus can be avoided, and reliability of the printed board on which the components are mounted can be improved.

Still further, even if the actual mounter on the manufacturing line is operating, the cassette loading positions in the carts can be checked at a location remote from the manufacturing line, and therefore, operational efficiency and workability can be improved.

### BRIEF DESCRIPTION OF THE DRAWINGS

FIG. 1A is a plan view of a printed board component mounting apparatus according to an embodiment of the present invention;

FIG. 1B is a perspective view of a printed board component mounting apparatus according to an embodiment of the present invention;

FIG. 2 is a diagram showing a cassette that accommodates one reel;

FIG. 3 is a diagram showing a cassette that accommodates two reels;

FIG. 4 is a diagram showing an operation support system in a printed board component mounting apparatus according to an embodiment of the present invention;

FIG. 5 is a diagram showing an automatic recognition mechanism for reeled components according to an embodiment of the present invention;

FIG. 6A is a diagram showing a table that stores identification information of a first reel;

FIG. 6B is a diagram showing a table that stores identification information of a second reel;

FIG. 7 is a diagram showing a table that stores cassette identification information;

FIG. 8A is a perspective view of an automatic verification device that verifies arrangement of cassettes loaded on carts and accommodated in lanes by collating components in the cassettes with components to be accommodated in the lanes according to an embodiment of the present invention;

FIG. 8B is a side view of the automatic verification device shown in FIG. 8A;

FIG. 8C is an enlarged view of a cassette identification information reading section P enclosed by a circle in FIG. 8B;

FIG. 9 is a diagram showing a table that stores component loading information;

FIG. 10 is a flow chart of a checking operation for component loading according to an embodiment of the present invention; and

FIG. 11 is a flow chart of a checking operation for cassette loading on a cart according to an embodiment of the present invention.

### EXPLANATION OF REFERENCES

1 Printed board component mounting apparatus (mounter)
2, 87 Cart
3, 20, 30, 50, 80 Cassette
4 Nozzle
5 Printed board
21, 31, 32, 51, 52, 81, 82 Reel
25, 35, 54, 56, 86, 88 Tag
40 Server
41 LAN
42, 43 Terminal
44, 46 Control unit
45 ID reading unit
47 Automatic verification apparatus
53 Component
55, 85, 89 Antenna
57, 58 Sensor

### BEST MODE FOR CARRYING OUT THE INVENTION

Hereinafter, the embodiments of the present invention will be described with reference to the drawings.

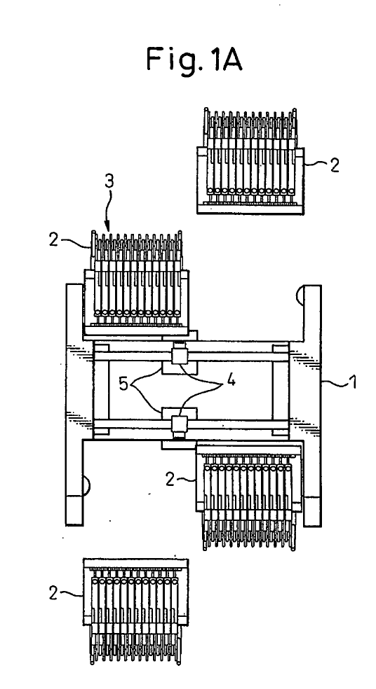

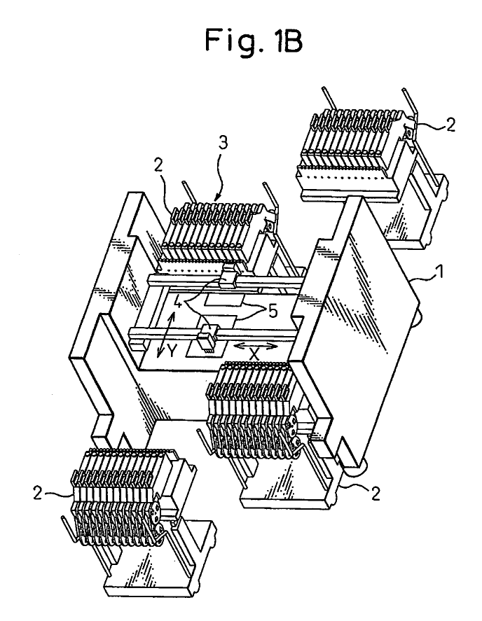

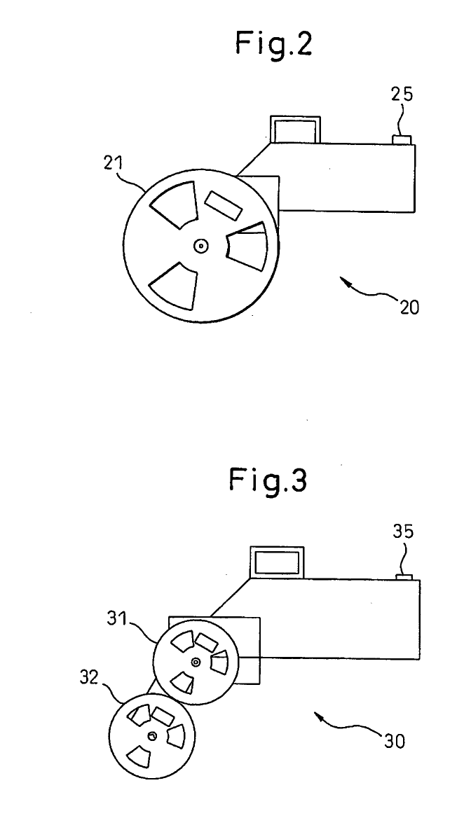

FIGS. 1A and 1B are diagrams showing a printed board component mounting apparatus according to an embodiment of the present invention, wherein FIG. 1A is a plan view and FIG. 1B is a perspective view. As shown in FIGS. 1A and 1B, four carts 2 can be removably loaded on a printed board component mounting apparatus (mounter) 1 that is installed on a manufacturing line for manufacturing printed board units where components are incorporated into printed boards. A plurality of cassettes 3 can be loaded on each cart 2. Two nozzles 4 are attached to the mounter 1 movably in two-axis directions along the X and Y axes, so that each nozzle 4 sucks components that are wound around reels (see FIGS. 2 and 3) in the cassettes 3 and carries it onto printed boards 5 that are located below the nozzle 4 to place the components at desired positions on the printed boards 5.

FIG. 2 is a diagram showing a cassette that accommodates one reel. One reel 21 is attached to the shown cassette 20. A tape, to which components to be mounted on the printed boards 5 are stuck, is wound, together with a sticker, around the reel 21. The cassette 20 has a function to feed and cut the tape pitch by pitch while taking up the sticker so that the nozzle 4 can suck the components one by one. The reel 21 can accommodate the components only of one type. Therefore, the cassette 20 of FIG. 2 to which only one reel can be attached can handle the components only of one type. A tag 25 is a wireless IC tag that stores information for identifying the cassette 20. The wireless IC tag is a minute wireless IC chip that has ability to transmit and receive low-power radio wave and that is used to identify objects and the wireless IC tag transmits and receives radio wave or electromagnetic wave to/from a reading unit.

FIG. 3 is a diagram showing a cassette that accommodates two reels. The shown cassette 30 has a function substantially identical to that of the cassette 20 shown in FIG. 2, except that the cassette 30 has two reels 31 and 32 attached thereto. A tag 35 may be identical to the tag 25. The cassette 30 has a function to cut the tapes while individually taking up the stickers wound around the respective reels 31 and 32. Each reel can accommodate the components only of one type, and therefore, the cassette 30 can accommodate the components of two types. If three or more reels are attached to the cassette, the cassette can accommodate the components of three or more types corresponding to the number of reels.

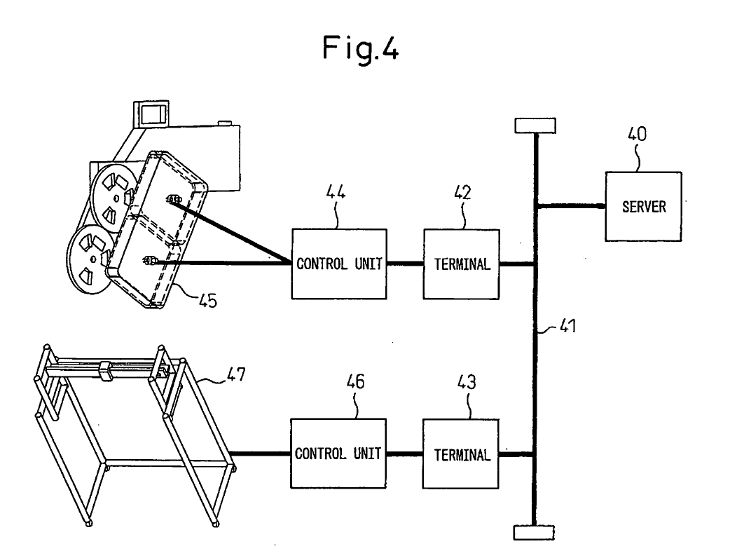

FIG. 4 is a diagram showing an operation support system in a printed board component mounting apparatus according to an embodiment of the present invention. A server 40 communicates with terminals 42 and 43 via a LAN 41. Component identification information refers to information for identifying the components that are attached to the reels accommodated in the cassettes, and cassette identification information refers to information for identifying the cassettes each of which accommodates at least one reel having the components attached thereto. The terminal 42 transmits the component identification information and the cassette identification information to the server 40. The terminal 43 transmits information about arrangement of a plurality of cassettes or more specifically, information indicating which cassettes are arranged in a plurality of lanes in the carts, to the server 40.

The terminal 42 is connected to a control unit 44. An ID reading unit 45 reads out the component identification information and the cassette identification information from the cassettes as described in detail below. The control unit 44 receives the component identification information and the cassette identification information read out by the ID reading unit 45 and transmits such information to the server 40 via the terminal 42 and the LAN 41. The server 40 stores the received component identification information and cassette identification information in a storage section in the server 40.

On the other hand, the terminal 43 is connected to the control unit 46. An automatic verification device 47 temporarily accommodates the carts so as to read out the arrangement information about the plurality of cassettes loaded on the carts and transmit the cassette arrangement information to the control unit 46. The control unit 46 transmits the cassette arrangement information to the server 40 via the terminal 43 and the LAN 41. The cassette arrangement information includes the identification information of the cassettes loaded on the carts and the address information of the lanes in the carts in which the cassettes are accommodated. The server 40 stores the arrangement information of the cassettes loaded on the carts in the storage section in the server 40.

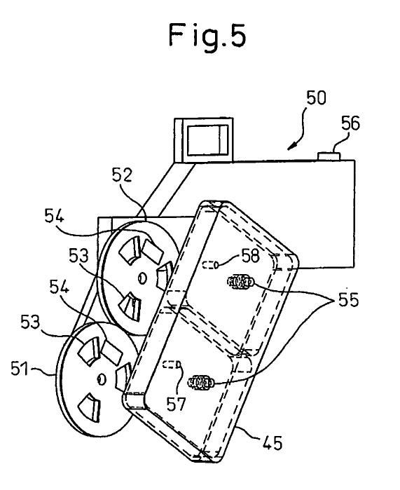

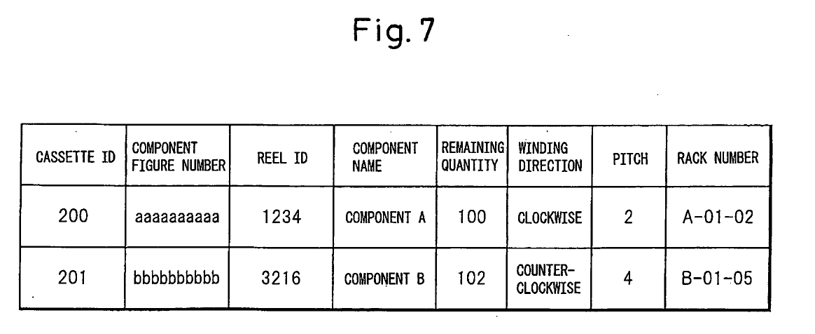

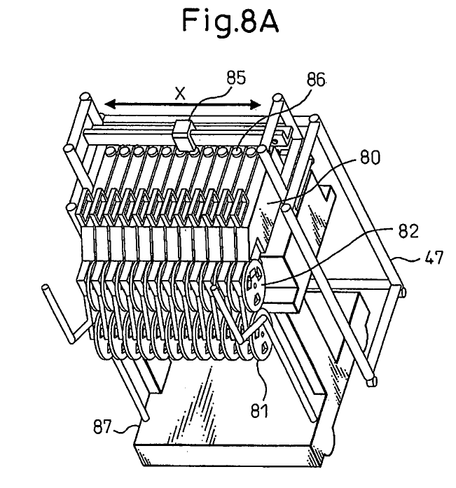

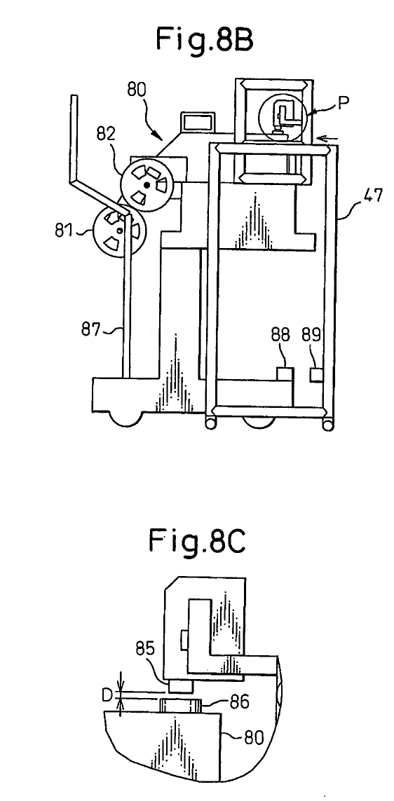

FIG. 5 is a diagram showing an automatic recognition mechanism for reeled components according to an embodiment of the present invention. The control unit 44 uses an ID reading unit 45 to read out identification information of the components 53 attached to the reels 51 and 52 that are, in turn, attached to the cassettes 50 or, in other words, reel identification information from tags (wireless IC tags) 54 attached to the reels via antennas 55. The ID reading unit 45 that accommodates the reels 51 and 52 and whose outer frame is formed of metal prevents interference to radio waves from the tags 54 to the antenna 55. Tags (wireless IC tags) 56 store the identification information of the cassettes 50. This cassette identification information is read out via an antenna 85 described below with reference to FIGS. 8A-8C. The cassette identification information will be described below with reference to FIG. 7. Sensors 57 and 58 detect presence or absence of the reels 51 and 52, respectively. In this embodiment, two antennas 55 are provided to receive the reel identification information stored in the tags (wireless IC tags) 54 attached to the respective reels 51 and 52 and transmit it to the control unit 44.

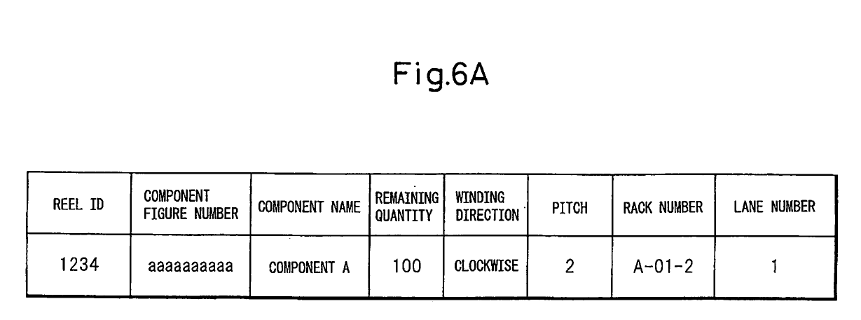

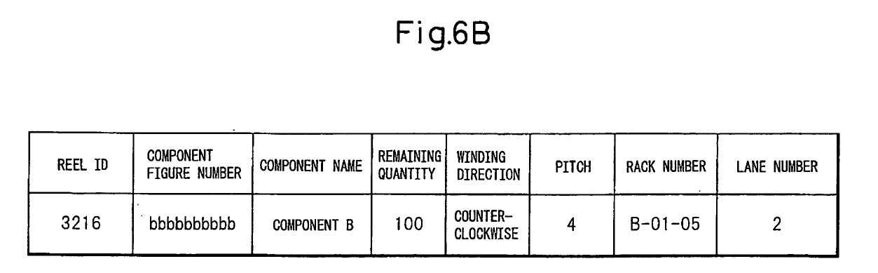

FIG. 6A is a diagram showing a table that stores identification information of a first reel, and FIG. 6B is a diagram showing a table that stores identification information of a second reel. In FIGS. 6A and 6B, the reel identification information is shown in the form of tables. The shown tables have eight columns such as: reel ID, component figure number, component name, remaining quantity, winding direction, pitch, rack number, and lane number, and store the information about the components. The tables shown in FIGS. 6A and 6B are stored in the tags 54, the storage section of the terminal 42 and the storage section of the server 40.

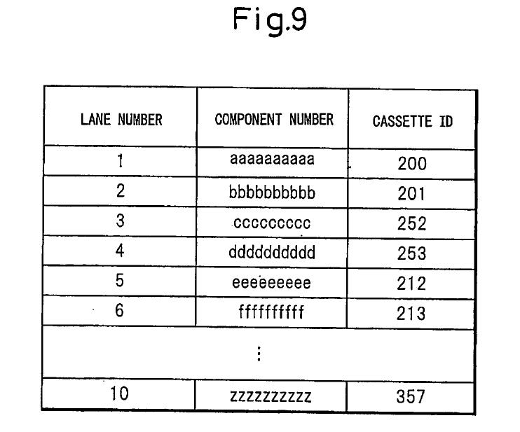

The reel ID is an information item for identifying each reel itself. The subsequent information items pertain to the reel identified by the reel ID. The component figure number is an information item for identifying the components loaded on the reel. In this embodiment, the components are managed by the component figure numbers and the component figure numbers are recorded also in tables shown in FIGS. 8 and 9 described below. Further, names of the components loaded on the reel are recorded in the column of the component name.

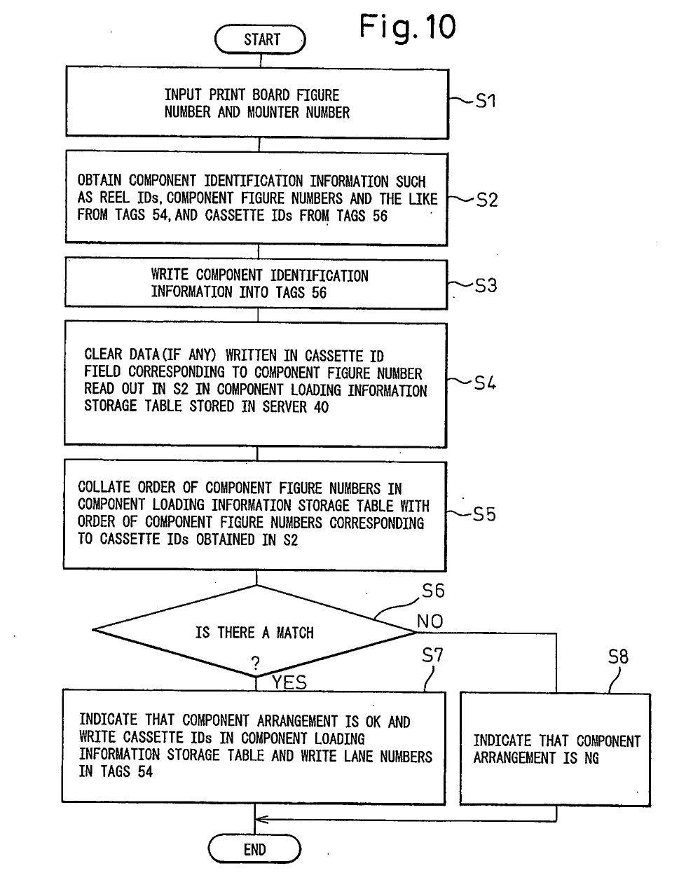

In the column of the remaining quantity, the quantity of the components remaining in the reel is recorded. In the column of the winding direction, data indicating whether the tape is wound around the reel clockwise or counter-clockwise is recorded. In the column of the pitch, a distance between the components attached to the tape wound around the reel is recorded. Further, in the column of the rack number, the number of the racks where the reel is accommodated is recorded. This rack number information is used when the reel is attached to the cassette or when the reel is removed from the cassette and stored in the rack, and so on. Still further, in the column of the lane number, the number indicating the position where the components are accommodated or in other words, the reel position, in the cassette loaded on the cart is recorded. The lane number may not be stored in the tags 54. The lane number column is blank at the start of the process of a component loading checking flow chart shown in FIG. 10 described below and it is written during the process of step S7.

The tag 56 (wireless IC tag) 56 is attached also to each cassette 50, and the ID reading unit 45 receives the cassette identification information stored in the tag 56 via the antennas 55 and transmits it to the control unit 44. The control unit 44 receives the cassette identification information and transmits it to the server 40 via the terminal 42. The server 40 receives the reel identification information of the components attached to the reels and the cassette identification information and stores it in the storage section.

FIG. 7 is a diagram showing a table that stores cassette identification information. The table shown in FIG. 7 has eight columns such as: cassette ID, component figure number, reel ID, component name, remaining quantity, winding direction, pitch, and rack number, and stores the information about the cassettes. In the column of the cassette ID, the cassette ID data for identifying the cassettes themselves is recorded. The cassette IDs are provided corresponding not to the cassettes but to the component figure numbers and the reel IDs. Therefore, when plural types of components contained in the reels are accommodated in one cassette, a plurality of cassette IDs are recorded corresponding to the components and the reels in the one cassette and, as a result, the one cassette is identified by the plurality of cassette IDs. For example, when the table of FIG. 7 shows an example in which two reels and, thus, two types of components are accommodated in one cassette, two cassette IDs 200 and 201 identify the cassette. When one type of components contained in one reel is accommodated in one cassette, one cassette ID for the one cassette is recorded corresponding to the components and the reel and the one cassette ID identifies the one cassette. On the other hand, in the columns of the component figure number, the reel ID, the component name, the remaining quantity, the winding direction, the pitch and the rack number, data items similar to those described above with reference to FIGS. 6A and 6B are recorded. The table shown in FIG. 7 is stored in the tags 56, the storage section of the terminal 43 and the storage section of the server 40.

FIGS. 8A-8C are diagrams showing the automatic verification device 47 that verifies the arrangement of the cassettes loaded on the carts and accommodated in the lanes according to an embodiment of the present invention. Fig. BA is a perspective view of the automatic verification device 47, FIG. 8B is a side view thereof, and FIG. 8C is an enlarged view of a cassette identification information reading section P enclosed by a circle in FIG. 8B.

The automatic verification device 47 is configured to be able to accommodate the carts 67 on each of which a plurality of cassettes 80 accommodating the reels 81 and 82 are loaded. A distance D between the antenna 85 and the tags 86 are configured so that communication is possible therebetween. The antenna 85 is slidable in both directions along the X-axis shown in FIG. 8A. The antenna 85 moves by itself in either direction along the X-axis to receive the information stored in the tags (wireless IC tags) 86 (identical to the tags 56 of FIG. 5) attached to the respective cassettes 80 or the cassette identification information. The cassette identification information also includes the component identification information that identifies the components attached to the reels 81 or 82. The received cassette identification information is transmitted to the terminal 43 via the control unit 46.

The automatic verification device 47 allows the terminal 43 to collate the information of the components in the cassettes 80 with the information of the components to be accommodated in each lane of the carts 87. When the information of the components to be accommodated in each lane of the cart 87 is verified, the control unit 46 controls the antenna 85 to move by itself to read out the cassette IDs in the cassette identification information stored in the tags 86. The terminal 43 receives the cassette IDs and the component figure numbers read out by the control unit 46 in order of lane numbers and compares the received data of the cassette IDs and the component figure numbers with the data of the cassette IDs or the component figure numbers registered in the component loading information storage table (shown in FIG. 9) in the server 40 to determine whether there is a match therebetween or not. If there is a match, a display (not shown) of the terminal 43 indicates that the verification is correct or in other words, the cassettes 80 are properly arranged in the cart 87 and, if there is no match, the display of the terminal 43 indicates that the verification is wrong or in other words, the cassettes 80 are improperly arranged in the cart 87.

The information for identifying the cart 87 is stored in a tag (wireless IC tag) 88 attached to the cart 87, and the automatic verification device 47 allows the control unit 46 to read out the identification information of the cart 87 via the antenna 89. In the mounter of this embodiment on which four carts are loaded, the read-out cart identification information includes cart numbers #1, #2, #3 and #4.

FIG. 9 is a diagram showing a table that stores component loading information. The table shown in FIG. 9 has three columns, i.e., lane number, component figure number, and cassette ID. In the column of the lane number, the lane numbers indicating the positions where the cassettes accommodated in the carts are loaded. In the column of the component figure number, the component figure numbers for identifying the components loaded on the cassettes are recorded. In the column of the cassette ID, the cassette IDs for identifying the cassettes are recorded. The table shown in FIG. 9 is stored in the storage section of the server 40. The table is a list of components arranged in the carts that is prepared for actually loading the components on objects, or in this embodiment, printed boards, in an actual mounter. When a process of a flow chart for checking component loading shown in FIG. 10 starts, only the data items of the lane number and the component figure number are written. It is to be noted that the data item of the cassette ID is blank at the start of the process of the flow chart for checking component loading shown in FIG. 10 and it is written during the process of step S7.

FIG. 10 is a flow chart of a checking operation for component loading according to an embodiment of the present invention. The process of this flow chart is performed after loading the reels on the cassettes as a component set up operation before actually mounting the components on the printed board in the actual mounter, so as to check whether the components attached to a plurality of reels are attached to correct reel positions or more specifically, reel positions when the components are mounted on the printed boards in the actual mounter or not. After this process is performed, if it is determined that the components are not attached to the correct reel positions, the reels in the cassettes are replaced, and then, the process of this flow chart is performed again.

In step S1, an operator inputs, from the terminal 42, a printed board figure number for specifying the printed boards on which the components are to be mounted, and a mounter number for specifying the actual mounter in which the components are mounted on such printed boards. As a result of the process of this step S1, the component loading information storage table shown in FIG. 9 can be transferred from the server 40 to the terminal 42 by using the specified printed board figure number and mounter number as a key. By performing the following process steps with reference to this table, it can be determined whether the components are properly arranged in the cassettes 50 or not.

In step S2, the ID reading unit 45 obtains the component identification information stored in the tags 54 of the reels 51 and 52 or, more specifically, the data items for each reel written in the columns such as: reel ID, component figure number, component name, remaining quantity, winding direction, pitch, and rack number. The reel IDs are data items indicating the information for identifying the reels 51 and 52 accommodated in the cassettes 50, and the component figure numbers are data items for identifying the components accommodated in each reel.

In step S3, the data items, i.e., component figure number, reel ID, component name, remaining quantity, winding direction, pitch, and rack number obtained from the tags of the reels in step S2 are written into the tag 56 of the cassettes 50. As a result of this writing operation, the component identification information written in the two reel identification information tables shown in FIGS. 6A and 6B is stored in the cassette identification information table shown in FIG. 7 that is provided in one cassette.

In step S4, the terminal 42 communicates with the server 40 to clear the cassette IDs read out in step S2 in the component loading information storage table shown in FIG. 9 that is stored in the storage section of the server 40.

In step S5, the terminal 43 communicates with the server 40 to collate the order of the component figure numbers in the component loading information storage table shown in FIG. 9 that is stored in the storage section of the server 40 and that corresponds to the lane number with the order of the component figure numbers aaaaaaaaaa and bbbbbbbbbb corresponding to the cassette IDs in the component identification information storage table that is obtained from the tag 56 in step S2.

In step S6, as a result of the collation in step S5, if there is a match, it is determined that the arrangement of the components in the cassettes 50 is correct, or in other words, the components in the cassettes 50 are attached to the proper reel positions and the process proceeds to step S7; however, if there is no match, it is determined that the components in the cassettes 50 are attached to improper reel positions and the process proceeds to step S8.

In step S7, the display of the terminal 42 indicates that the arrangement of the components in the cassettes is correct (OK) and, then, the cassette IDs corresponding to the component figure numbers aaaaaaaaaa and bbbbbbbbbb are written into the cassette ID column that is cleared in step S4 in the component loading information storage table stored in the storage section of the server 40 and the lane numbers 1 and 2 corresponding to the component figure numbers aaaaaaaaaa and bbbbbbbbbb in the component loading information storage table are written into the tag 54.

In step S8, the display of the terminal 42 indicates that the arrangement of the components in the cassettes is not correct (NG). In response to this indication, the operator corrects the arrangement of the components in the cassettes by interchanging the reels in the cassettes to be arranged properly.

By performing the flow of checking the component loading described above, the cassettes and the reels can be recognized in the state where the components and the reels are loaded on the cassettes, and therefore, it is possible to properly recognize which components are accommodated in which reel positions in the cassettes so as to mount the properly recognized components on the printed boards and, as a result, eliminate erroneous mounting. Further, even if the actual mounter on the manufacturing line is operating, by performing the above-described flow of checking the component loading at a location remote from the manufacturing line, it can be checked where the components are loaded in the cassette, and therefore, operational efficiency and workability can be improved.

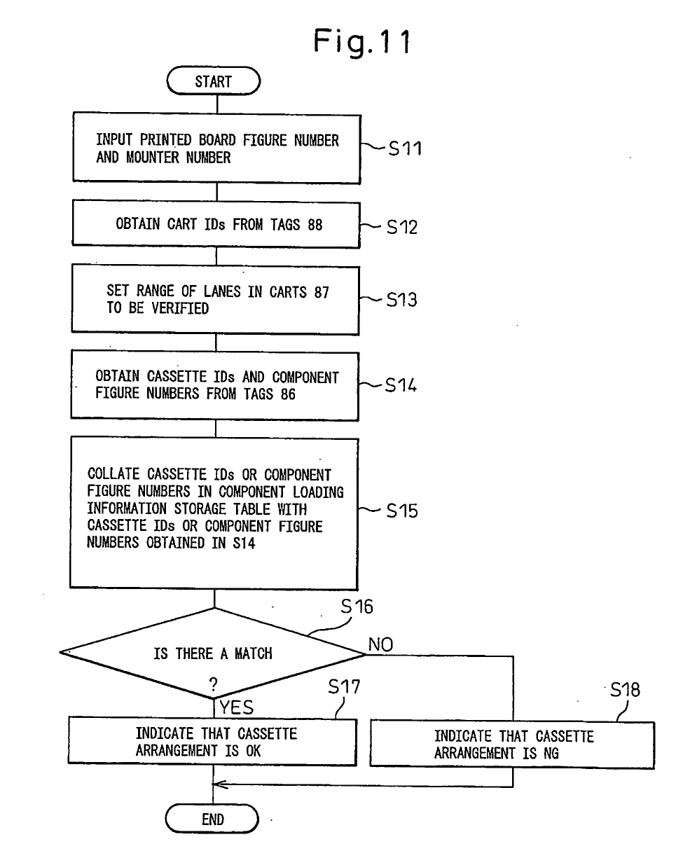

FIG. 11 is a flow chart of a checking operation for cassette loading on carts according to an embodiment of the present invention. The process of this flow chart is performed after loading the cassettes on the carts as a cassette set up operation before actually mounting the components on the printed boards in the actual mounter, so as to check whether the components attached to a plurality of cassettes in the carts are loaded on correct lane positions of the carts. After this process is performed, if it is determined that the cassettes are not loaded at the correct lane positions, the cassettes in the carts are replaced, and then, the process of the flow chart is performed again.

In step S11, the operator inputs, from the terminal 43, a printed board figure number for specifying the printed boards on which the components are to be mounted, and a mounter number for specifying the actual mounter in which the components are mounted on such printed boards. As a result of the process of this step S1, the component loading information storage table shown in FIG. 9 can be transferred from the server 40 to the terminal 43. By performing the following process steps with reference to this table, it can be determined whether the cassettes are properly arranged in the carts or not.

In step S12, the automatic verification device 47 obtains the cart IDs from the tag 88. Four carts are loaded on the mounter of this embodiment shown in FIG. 1B, and therefore, by obtaining cart identification data items (cart IDs) stored in the tags attached to the respective carts, the positions of the carts loaded on the mounter can be identified.

In step S13, the range of the lanes to be verified in the carts 87 is set. When there are four carts and each of the carts comprises 70 lanes, with respect to the carts in which it is checked whether the cassettes are properly arranged or not, lanes 1-70 for the cart identified by cart ID 1, lanes 71-140 for the cart identified by cart ID 2, lanes 141-210 for the cart identified by cart ID 3, and lanes 211-280 for the cart identified by cart ID 4 are set as the range of the lanes to be verified.

In step S14, the automatic verification device 47 obtains the cassette IDs and the component figure numbers stored in the tags 86 of the cassettes 80. The antenna 85 in the automatic verification device 47 moves by itself and reads the tags 86 to correlate the positions of the antenna 85 with the lane positions on the cart 87, and further, collate the information items such as the cassette IDs read out by the antenna 85 with the positions of the antenna 85 at the time of reading, so as to determine which cassettes are loaded at which lane positions on the carts 87.

In step S15, communication with the server 40 is made to collate, for every lane, the cassette IDs or the component figure numbers in the component loading information storage table stored in the server 40 with the cassette IDs or the component figure numbers obtained from the tags 86 by the automatic verification device 47 in step S14. As a result of this process, by collating the arrangement of the cassettes in the carts that are used when the components are actually mounted on the printed boards in the actual mounter with the arrangement of the cassettes in the carts read out by the automatic verification device 47, it can be checked whether the cassettes are properly arranged and loaded at lane positions of the carts.

In step S16, as a result of the collation in step S15, if there is a match, it is determined that the arrangement of the cassettes in the carts is correct or, in other words, the cassettes in the carts are arranged at the proper lane positions and the process proceeds to step S17 and, on the other hand, if there is no match, it is determined that the cassettes in the carts are arranged at improper lane positions and the process proceeds to step S18.

In step S17, the display of the terminal 43 indicates that the arrangement of the cassettes in the carts is correct (OK).

In step S18, the display of the terminal 43 indicates that the arrangement of the cassettes in the carts is not correct (NG). In response to this indication, the operator corrects the arrangement of the cassettes in the carts by interchanging the cassettes in the carts to be arranged properly.

By performing the flow of checking the cassette loading described above, the antenna moves by itself to read out the cassette IDs and the component figure numbers for identifying the cassettes loaded on the plurality of lanes so as to collate the read-out cassette IDs or component figure numbers with the cassette IDs or component figure numbers in the component loading information storage table specifying the arrangement of the cassettes loaded on the carts used in the actual mounter, and therefore, operating time for loading the cassettes on the proper lane positions in the carts can be reduced and workability can be improved, and moreover, erroneous mounting of the components on the printed boards due to erroneous operation when the cassettes are loaded on the lanes can be avoided. Further, even if the actual mounter on the manufacturing line is operating, by performing the above-described flow of checking the cassette loading at a location remote from the manufacturing line, it can be checked where the cassettes are loaded in the carts, and therefore, operational efficiency and workability can be improved.

In the embodiments described above, though examples using the wireless IC tags and the antenna for receiving the data recorded in the wireless IC tags have been described, bar codes may be used in place of the wireless IC tags and a bar code reader may be used in place of the antenna.

Though the embodiments of the present invention have been described, the present invention is not limited to the above-described embodiments and various embodiments may be adopted.

1. An operation support system in a component mounting apparatus for mounting components on objects, characterized in that it comprises:
a reading unit that reads out cassette identification information and component identification information from cassettes, wherein each of the cassettes comprises: a first recording section that records said component identification information for identifying components contained in at least one reel accommodated in the cassettes, and a second recording section that records said cassette identification information for identifying said cassettes;
a storage unit that stores information for specifying the components previously set to be loaded on the cassettes; and
a component loading checking unit that checks whether the components loaded on said cassettes are correct ones or not by comparing said component identification information with said specifying information corresponding to said cassette identification information.

2. An operation support system in a component mounting apparatus for mounting components on objects, characterized in that it comprises:
a reading unit that reads out cassette identification information and component identification information from cassettes, wherein each of the cassette comprises: a first recording section that records said component identification information for identifying components contained in at least one reel accommodated in the cassettes, and a second recording section that records said cassette identification information for identifying said cassettes;
a storage unit that stores information for specifying loading positions of the components set in said component mounting apparatus; and
a component loading checking unit that checks whether the component loading positions in said component mounting apparatus are correct or not by comparing said component identification information with said specifying information corresponding to said cassette identification information.

3. An operation support system according to claim 1, wherein said cassette identification information includes at least information for identifying reels loaded on the cassettes, or components attached to said reels.

4. An operation support system according to claim 1, wherein said first recording section is provided for each reel, and said reading unit reads out said component identification information for each reel.

5. An operation support system according to claim 1, wherein said first and/or second recording sections are bar codes for recording data, and said reading unit has a bar code reader for reading said bar codes.

6. An operation support system according to claim 1, wherein said first and/or second recording sections are wireless IC tags for recording data, and said reading unit has an antenna for receiving radio wave from said wireless IC tags and reads out said data via such antenna.

7. An operation support system in a component mounting apparatus for mounting components on objects, characterized in that it comprises:
a reading section that moves by itself to positions where cassettes are loaded on carts each having a plurality of lanes to read out, from said cassettes, at least one of component identification information for identifying components loaded on said cassettes and cassette identification information for identifying said cassettes;
a storage section that stores information for specifying previously set cassette loading positions in said carts; and
a cassette loading checking section that checks whether the cassette loading positions in said carts are correct or not by comparing said component identification information of said cassette identification information with said specifying information.

8. An operation support system in a component mounting apparatus for mounting components on objects, characterized in that it comprises:
a reading section that moves by itself to positions where cassettes are loaded on carts each having a plurality of lanes to read out cassette identification information for identifying the cassettes from said cassettes;
a storage section that stores information for specifying lanes where the cassettes are loaded in said carts; and
a cassette loading checking section that checks whether cassette loading positions in said carts are correct or not by comparing said cassette identification information read out by said reading section with said lane specifying information.

9. An operation support system in a component mounting apparatus for mounting components on objects, characterized in that it comprises:
a reading section that moves by itself to positions where cassettes are loaded on carts each having a plurality of lanes to read out, from said cassettes, component identification information for identifying components loaded on the cassettes;
a storage section that stores information for specifying lanes where said components are loaded in said carts; and
a component loading checking section that checks whether component loading positions in said carts are correct or not by comparing said component identification information read out by said reading section with said lane identification information.

10. An operation support system according to claim 7, wherein a plurality of carts can be loaded on said component loading apparatus, each of said carts comprises a third recording section that records cart identification information for identifying such cart, and said cassette loading checking section checks a cassette loading arrangement in each cart.

11. An operation support system according to claim 10, wherein said recording section is bar codes for recording data, and said cassette loading checking section has a bar code reader for reading said bar codes.

12. An operation support system according to claim 10, wherein said recording section is wireless IC tags for recording data, and said cassette loading checking section has an antenna for receiving radio wave from said wireless IC tags and reading out said data via such antenna.

13. A recognition method for recognizing a loading state of components in cassettes accommodating reels to which components are attached, characterized by comprising the steps of:
reading out information for identifying the components accommodated in said cassettes;
specifying information for specifying positions of the components accommodated in said cassettes; and
determining whether the loading positions of said components in the cassettes are the specified ones or not by comparing said read-out component identification information with said specifying information.

14. A recognition method according to claim 13, wherein, in a state in which one or a plurality of said reels are loaded on said cassettes, said reading out step reads out information for specifying said reels and/or information for specifying the components loaded on said reels from a first storage section attached to said reels, and the recognition method further comprises the step of writing said read-out reel specifying information and/or component specifying information into a second storage section provided in said cassettes.

15. A recognition method for recognizing a loading state of cassettes, on which components are loaded, on carts, characterized by comprising the steps of:
reading out information for specifying the cassettes loaded on said carts or the components loaded on the cassettes;
specifying information for specifying positions of the cassettes loaded on said carts; and
determining whether the loading positions of said cassettes on said carts are the specified ones or not by comparing said read-out identification information with said specifying information.

16. A recognition method according to claim 15, wherein said reading out step comprises the step of reading out said identification information by a movable reading section from the cassettes loaded on said carts, and said determining step determines the mounting positions of said cassettes on the carts based on the reading of said identification information.

17. An operation support system according to claim 2, wherein said cassette identification information includes at least information for identifying reels loaded on the cassettes, or components attached to said reels.

18. An operation support system according to claim 17, wherein said first recording section is provided for each reel, and said reading unit reads out said component identification information for each reel.

19. An operation support system according to claim 18, wherein said first and/or second recording sections are bar codes for recording data, and said reading unit has a bar code reader for reading said bar codes.

20. An operation support system according to claim 18, wherein said first and/or second recording sections are wireless IC tags for recording data, and said reading unit has an antenna for receiving radio wave from said wireless IC tags and reads out said data via such antenna.

21. An operation support system according to claim 8, wherein a plurality of carts can be loaded on said component loading apparatus, each of said carts comprises a third recording section that records cart identification information for identifying such cart, and said cassette loading checking section checks a cassette loading arrangement in each cart.

22. An operation support system according to claim 9, wherein a plurality of carts can be loaded on said component loading apparatus, each of said carts comprises a third recording section that records cart identification information for identifying such cart, and said cassette loading checking section checks a cassette loading arrangement in each cart.

23. An operation support system according to claim 21, wherein said recording section is bar codes for recording data, and said cassette loading checking section has a bar code reader for reading said bar codes.

24. An operation support system according to claim 22, wherein said recording section is bar codes for recording data, and said cassette loading checking section has a bar code reader for reading said bar codes.

25. An operation support system according to claim 21, wherein said recording section is wireless IC tags for recording data, and said cassette loading checking section has an antenna for receiving radio wave from said wireless IC tags and reading out said data via such antenna.

26. An operation support system according to claim 22, wherein said recording section is wireless IC tags for recording data, and said cassette loading checking section has an antenna for receiving radio wave from said wireless IC tags and reading out said data via such antenna.
